(19) United States
(12) Patent Application Publication
(10) Pub. No.: US 2023/0150654 A1
(43) Pub. Date: May 18, 2023

(54) Novel jet-propelled lift-increasing and stability-increasing amphibious aircraft and application method thereof

(71) Applicant: Sun Yat-sen University, Guangzhou (CN)

(72) Inventors: Rui DENG, Guangzhou (CN); Fugiang LUO, Guangehou (CN); Tiecheng WU, Guangzhou (CN); Pengnan SUN, Guangzhou (CN); Wanzhen LUO, Guangehou (CN); Zezhen ZHANG, Guangzhou (CN); Siyuan CHEN, Guangzhou (CN)

(21) Appl. No.: 17/624,358

(22) PCT Filed: Jan. 12, 2021
(86) PCT No.: PCT/CN2021/071317

§ 371 Date: Jan. 3, 2022

(30) Foreign Application Priority Data
Aug. 26, 2020 (CN) 202010871872.0

(51) Int. Cl. B64C 15/14; B64D 45/00; B64C 35/00; G05D 1/08

(52) U.S. Cl. CPC B64C 15/14; B64C 35/008; B64D 45/00; G05D 1/0816

(57) ABSTRACT

Disclosed is a novel jet-propelled lift-increasing and stability-increasing amphibious aircraft and an application method thereof. An air intake fan connects and communicates with an air intake end of a pressurized air storage tank, an air outlet end of the pressurized air storage tank connects and communicates with a shunting pipeline, the shunting pipeline respectively connects and communicates with a plurality of air chambers, each connection of the plurality of air chambers and the shunting pipeline is provided with an adjusting valve, and the plurality of air chambers are distributed in a plurality of positions of the bottom of the aircraft, and are configured to jet air outwards. A navigation state sensing device is configured to detect navigation data of the aircraft and send the navigation data to an intelligent analysis device. The intelligent analysis device is configured to analyze the navigation data, obtain a control scheme and send to a jet control device. The jet control device controls open and closed states of the adjusting valves according to the control scheme to adjust a jet state of the plurality of air chambers. By adjusting the jet quantity of each position of the bottom of the aircraft from various positions, the aircraft is assisted to stably fly. The problems in the prior art are practically solved.

### TECHNICAL FIELD

The disclosure relates to the field of amphibious aircraft, more particularly relates to a novel jet-propelled lift-increasing and stability-increasing amphibious aircraft and an application method thereof.

### BACKGROUND

An amphibious aircraft is developed on the basis of a seaplane, is provided with a fuselage having a boat body appearance and an undercarriage device capable of taking off and landing on the land, and can meet the takeoff and landing requirements of various environments such as water surface, land and intertidal zone. Through its applicable working environments, the amphibious aircraft needs to repeatedly take off and land on the water surface. Particularly when executing a maritime task, the amphibious aircraft often faces different conditions of sea waves, etc.

Due to the influence by wind, currents and waves during takeoff and landing on the sea, a conventional amphibious aircraft is difficult to take off and land, and the takeoff and landing distance and the takeoff and landing speed are far higher than those of other aircraft. Particularly, under high sea conditions, the aircraft violently moves under the influence of sea surface wind and waves, is difficult to take off and land, and is more dangerous. This problem of the amphibious aircraft severely limits its use frequency and use range.

In order to solve the shortcoming of the conventional amphibious aircraft, shorten the takeoff and landing time and distance, improve the safety and stability of the takeoff and landing process and realize the large-scale and sea-keeping of the amphibious aircraft, an amphibious aircraft capable of solving the problems is urgently needed.

### SUMMARY

The disclosure is directed to provide a novel jet-propelled lift-increasing and stability-increasing amphibious aircraft and an application method thereof to solve the problem of poor stability of an amphibious aircraft.

In order to solve the above technical problem, the disclosure provides a novel jet-propelled lift-increasing and stability-increasing amphibious aircraft, including an air intake fan, a pressurized air storage tank, a shunting pipeline, a navigation state sensing device, an intelligent analysis device, a jet control device and a plurality of air chambers. The air intake fan connects and communicates an air intake end of the pressurized air storage tank, an air outlet end of the pressurized air storage tank connects and communicates with the shunting pipeline, the shunting pipeline respectively connects and communicates with the plurality of air chambers, each connection of the plurality of air chambers and the shunting pipeline is provided with an adjusting valve, and the plurality of air chambers are distributed in a plurality of positions of the bottom of the novel jet-propelled lift-increasing and stability-increasing amphibious aircraft, and are configured to jet air outwards. The navigation state sensing device is configured to detect navigation data of the novel jet-propelled lift-increasing and stability-increasing amphibious aircraft and send the navigation data to the intelligent analysis device. The intelligent analysis device is configured to analyze the navigation data, obtain a control scheme and send to the jet control device. The jet control device controls open and closed states of the adjusting valves according to the control scheme to adjust a jet state of the plurality of air chambers.

In one embodiment, bottom walls of the air chambers are jet plates, each of the jet plates are provided with a plurality of jet holes, and the jet plates are used as bottom plates of the novel jet-propelled lift-increasing and stability-increasing amphibious aircraft.

In one embodiment, the air chambers are disposed between a bow portion and a step, at the step, and between the step and a stern of the novel jet-propelled lift-increasing and stability-increasing amphibious aircraft.

In one embodiment, the navigation state sensing device includes a GPS velometer, an attitude sensor and pressure sensors. The GPS velometer is configured to acquire real-time velocity, acceleration and three-dimensional coordinate information of the novel jet-propelled lift-increasing and stability-increasing amphibious aircraft. The attitude sensor is configured to acquire angular velocity, course angle and attitude angle information of the novel jet-propelled lift-increasing and stability-increasing amphibious aircraft. The pressure sensors are disposed in the air chambers, and are configured to acquire air pressure information in the air chambers.

In one embodiment, the navigation state sensing device further includes electronic flowmeters disposed at the adjusting valves, and the electronic flowmeters measure the flow rate of air flowing into the air chambers.

In order to solve the above technical problem, the disclosure provides an application method of the novel jet-propelled lift-increasing and stability-increasing amphibious aircraft. The application method is used to control the novel jet-propelled lift-increasing and stability-increasing amphibious aircraft, and includes: in a stage that the novel jet-propelled lift-increasing and stability-increasing amphibious aircraft planes on the surface to take off, dividing the stage of taxiing takeoff on the water surface into a hull-borne stage, a transition stage, a planing stage and a before-takeoff stage in different jet control modes; in a stage that the novel jet-propelled lift-increasing and stability-increasing amphibious aircraft leaves away from water and takes off to climb, dividing the water leaving takeoff climbing stage into a first stage of climb and a second stage of climb in different jet control modes; in a stage that the novel jet-propelled lift-increasing and stability-increasing amphibious aircraft flies in the air, adjusting the jet control mode in a matched manner according to navigation data; and in a stage that the novel jet-propelled lift-increasing and stability-increasing amphibious aircraft lands on water, dividing the on-water landing stage into a landing in-air stage, a water contacting impact stage and a water surface planing stage in different jet control modes.

In one embodiment, the application method includes: in the hull-borne stage, controlling the air chambers at the stern of the novel jet-propelled lift-increasing and stability-increasing amphibious aircraft for main jetting, controlling the air chambers at the bow portion of the novel jet-propelled lift-increasing and stability-increasing amphibious aircraft for auxiliary jetting, and controlling the air chambers at the step of the novel jet-propelled lift-increasing and stability-increasing amphibious aircraft to stop jetting; in the transition stage, controlling the air chambers at the bow portion of the novel jet-propelled lift-increasing and stability-increasing amphibious aircraft not to jet, increasing the jet quantity of the air chambers at the stern of the novel jet-propelled lift-increasing and stability-increasing amphibious aircraft, and retarding the jet quantity of the air chambers at the step of the novel jet-propelled lift-increasing and stability-increasing amphibious aircraft; in the planing stage, increasing the jet quantity of the air chambers at the step and the stern of the novel jet-propelled lift-increasing and stability-increasing amphibious aircraft; and in the before-takeoff stage, controlling all of the air chambers to jet to achieve main jetting through the air chambers at the step and near the step of the novel jet-propelled lift-increasing and stability-increasing amphibious aircraft and the auxiliary jetting through the air chambers near the bow portion and the stern of the novel jet-propelled lift-increasing and stability-increasing amphibious aircraft.

In one embodiment, the application method includes: in the first stage of climb, controlling all of the air chambers to jet, fast increasing the jet quantity of the air chambers at the bow portion of the novel jet-propelled lift-increasing and stability-increasing amphibious aircraft when trim by bow occurs, and fast increasing the jet quantity of the air chambers at the stern of the novel jet-propelled lift-increasing and stability-increasing amphibious aircraft when trim by stern occurs; and in the second stage of climb, increasing the jet quantity of the air chambers at the step of the novel jet-propelled lift-increasing and stability-increasing amphibious aircraft, and decreasing the jet quantity of the air chambers at the bow portion of the novel jet-propelled lift-increasing and stability-increasing amphibious aircraft.

In one embodiment, the application method includes: in the in-air flying stage, controlling the air chambers at the bow portion of the novel jet-propelled lift-increasing and stability-increasing amphibious aircraft not to jet, controlling the air chambers at the step of the novel jet-propelled lift-increasing and stability-increasing amphibious aircraft for main jetting, and controlling the air chambers at the stern of the novel jet-propelled lift-increasing and stability-increasing amphibious aircraft for auxiliary jetting; and when trim by stern occurs, increasing the jet quantity of the air chambers at the stern of the novel jet-propelled lift-increasing and stability-increasing amphibious aircraft, and when trim by bow occurs, decreasing the jet quantity of the air chambers at the stern of the novel jet-propelled lift-increasing and stability-increasing amphibious aircraft.

In one embodiment, the application method includes: in the in-air landing stage, when an amplitude of trim by bow is greater than a preset thresholdh, fast increasing the jet quantity of the air chambers at the bow portion of the novel jet-propelled lift-increasing and stability-increasing amphibious aircraft, and when the amplitude of trim by bow is smaller than the preset threshold, increasing the jet quantity of the air chambers at the stern of the novel jet-propelled lift-increasing and stability-increasing amphibious aircraft; in the water contacting impact stage, fast increasing the jet quantity of the air chambers at the bow portion and the step of the novel jet-propelled lift-increasing and stability-increasing amphibious aircraft, and fast adjusting the jet quantity of the air chambers at the stern of the novel jet-propelled lift-increasing and stability-increasing amphibious aircraft according to attitude characteristics after water entering; and in the water surface planing stage, firstly decreasing the jet quantity of the air chambers at the bow portion of the novel jet-propelled lift-increasing and stability-increasing amphibious aircraft, then decreasing the jet quantity of the air chambers at the stern of the novel jet-propelled lift-increasing and stability-increasing amphibious aircraft, and finally switching off the jet of all of the air chambers.

The disclosure has the following beneficial effects:

The plurality of air chambers are distributed in a plurality of positions of the bottom of the novel jet-propelled lift-increasing and stability-increasing amphibious aircraft, the plurality of air chambers are configured to jet outwards, and the jet control device controls the open and closed states of the adjusting valves according to the control scheme to adjust the jet state of the plurality of air chambers, so that the disclosure can adjust the jet quantity of each position of the bottom of the novel jet-propelled lift-increasing and stability-increasing amphibious aircraft from various positions to assist the novel jet-propelled lift-increasing and stability-increasing amphibious aircraft to stably fly, and the problem in the prior art is practically solved.

### BRIEF DESCRIPTION OF FIGURES

To describe the technical solutions of the disclosure more clearly, the following briefly describes accompanying drawings required for describing the implementations. Apparently, the following described accompanying drawings are only some of the implementations of the disclosure, and those of ordinary skill in the art may still derive other drawings from these accompanying drawings without creative efforts.

FIG. 1 is a lateral sectional structure view provided according to an embodiment of a novel jet-propelled lift-increasing and stability-increasing amphibious aircraft of the disclosure.

FIG. 2 is a top sectional structure view of FIG. 1

FIG. 3 is a front structural view of FIG. 1.

FIG. 4 is an enlarged structural view of an air chamber in FIG. 1.

In the figures

| | |
|---|---|
| 10 | denotes an air intake fan; |
| 20 | denotes a pressurized air storage tank; |
| 30 | denotes a shunting pipeline; |
| 41 | denotes a GPS velometer; |
| 42 | denotes an attitude sensor; |
| 43 | denotes a pressure sensor; |
| 44 | denotes an information transmission module; |
| 50 | denotes an intelligent analysis device; |
| 60 | denotes a jet control device; |
| 70 | denotes an air chamber; |
| 71 | denotes a jet plate; |
| 72 | denotes a jet hole; and |
| 80 | denotes an adjusting valve. |

### DETAILED DESCRIPTION

The following clearly and completely describes the technical solutions in the implementations of the disclosure with reference to the accompanying drawings in the implementations of the disclosure.

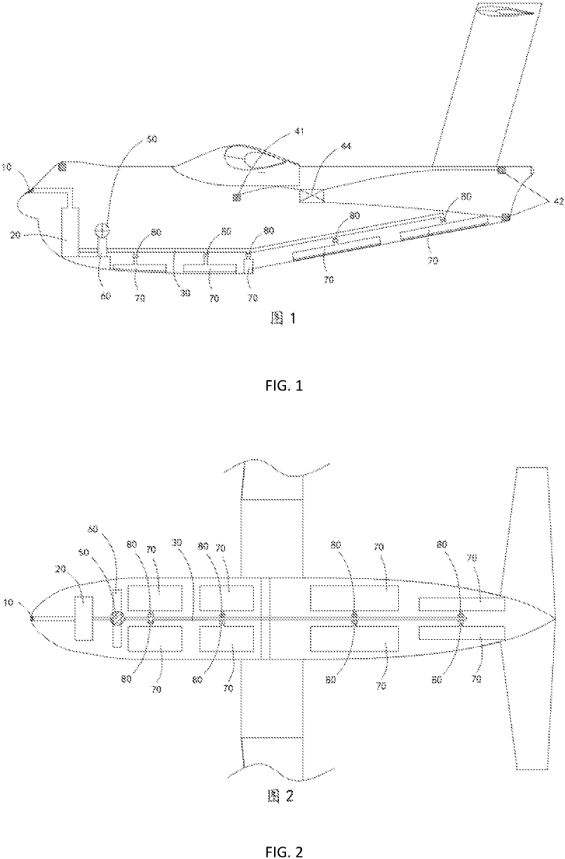

The disclosure provides a novel jet-propelled lift-increasing and stability-increasing amphibious aircraft, as shown in FIG. 1, including an air intake fan 10, a pressurized air storage tank 20, a shunting pipeline 30, a navigation state sensing device, an intelligent analysis device 50, a jet control device 60 and a plurality of air chambers 70. The air intake fan 10 connects and communicates an air intake end of the pressurized air storage tank 20, an air outlet end of the pressurized air storage tank 20 connects and communicates with the shunting pipeline 30, the shunting pipeline 30 respectively connects and communicates with the plurality of air chambers 70, each connection of the plurality of air chambers 70 and the shunting pipeline 30 is provided with an adjusting valve 80, and the plurality of air chambers 70 are distributed in a plurality of positions of the bottom of the novel jet-propelled lift-increasing and stability-increasing amphibious aircraft, and are configured to jet air outwards. The navigation state sensing device is configured to detect navigation data of the novel jet-propelled lift-increasing and stability-increasing amphibious aircraft and send the navigation data to the intelligent analysis device 50. The intelligent analysis device 50 is configured to analyze the navigation data, obtain a control scheme and send to the jet control device 60. The jet control device 60 controls open and closed states of the adjusting valves 80 according to the control scheme to adjust a jet state of the plurality of air chambers 70.

During application, the air intake fan 10 may extract air and supply the air to the pressurized air storage tank 20 for pressurized storage. Then, the navigation state sensing device may monitor various navigation data of the novel jet-propelled lift-increasing and stability-increasing amphibious aircraft in real time. After the intelligent analysis device 50 analyzes the navigation data, an optimum jet control scheme can be obtained. The jet control device 60 then controls the corresponding air chambers 70 to jet the air, thus achieving stable flight.

In the application process, the intelligent analysis device 50 automatically selects the jet working condition most favorable for the amphibious aircraft to improve the lift force characteristics and navigation stability in a database according to the motion attitude, the water contacting position, the resistance and lift force conditions when the amphibious aircraft takes off and lands.

As shown in FIG. 1, the air intake fan 10 of this embodiment is disposed at the front side of the bow of the amphibious aircraft, so when the amphibious aircraft advances, the air intake fan 10 may face the wind by the front side, thus improving the air intake efficiency.

As shown in FIG. 1, an air intake end of the pressurized air storage tank 20 is disposed at an upper portion of the bow, an air outlet end is disposed at a lower portion of the bow, and after the air intake end of the pressurized air storage tank 20 connects and communicates with the air intake fan 10, air storage and pressurization can be achieved, so that the pressurized air can be output from the air outlet end.

As shown in FIG. 1, the jet control device 60 connects and communicates the air outlet end of the pressurized air storage tank 20, and the intelligent analysis device 50 connects with the jet control device 60, so after the intelligent analysis device 50 obtains the optimum control scheme, the control scheme can be fast sent to the jet control device 60, the jet control device 60 can immediately adjust the air outlet volume of the pressurized air storage tank 20 and the open and closed states of each of the adjusting valves 80.

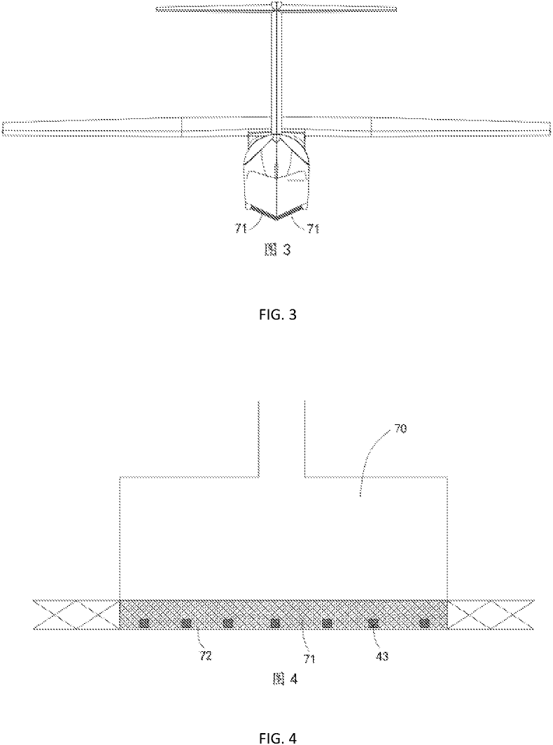

As shown in FIG. 1 to FIG. 4, at the moment, the air chambers 70 are disposed between a bow portion and a step, at the step, and between the step and a stern of the novel jet-propelled lift-increasing and stability-increasing amphibious aircraft, thus achieving the full coverage of the air chambers 70 at a bottom surface of a fuselage of the amphibious aircraft, and the jet control can be conveniently achieved on different positions in different scenes.

Specifically, four groups of air chambers 70 disposed in a matrix manner are disposed between the bow portion and the step of the novel jet-propelled lift-increasing and stability-increasing amphibious aircraft. A group of air chambers 70 are disposed at the step of the novel jet-propelled lift-increasing and stability-increasing amphibious aircraft, and are disposed in an extending manner in a width direction of the novel jet-propelled lift-increasing and stability-increasing amphibious aircraft. Four groups of air chambers 70 disposed in a matrix manner are disposed between the step and the stern of the novel jet-propelled lift-increasing and stability-increasing amphibious aircraft. That is, the total number of the air chambers 70 is nine groups. The jet control device 60 can achieve the independent control on the jet quantity of the nine groups of air chambers 70 through the adjusting valves 80.

Additionally, according to this embodiment, bottom walls of the air chambers 70 are jet plates 71, each of the jet plates 71 is provided with a plurality of jet holes 72, and the jet plates 71 are used as bottom plates of the novel jet-propelled lift-increasing and stability-increasing amphibious aircraft, so that the appearance of the jet plates 71 are matched with the appearance of the amphibious aircraft, a streamline configuration of the bottom surface of the amphibious aircraft cannot be damaged, and guarantee is further provided for the stable flight of the amphibious aircraft.

Further, at the moment, dismountable installation structures may also be disposed between the jet plates 71 and the air chambers 70, so that the jet plates 71 can be conveniently replaced and repaired.

As shown in FIG. 1 and FIG. 4, the navigation state sensing device includes a GPS velometer 41, an attitude sensor 42 and pressure sensors 43. The GPS velometer 41 is configured to acquire real-time velocity, acceleration and three-dimensional coordinate information of the novel jet-propelled lift-increasing and stability-increasing amphibious aircraft. The attitude sensor 42 is configured to acquire angular velocity, course angle and attitude angle information of the novel jet-propelled lift-increasing and stability-increasing amphibious aircraft. The pressure sensors 43 are disposed in the air chambers 70, and are configured to acquire air pressure information in the air chambers 70.

At the moment, the GPS velometer 41 is disposed in a position of a middle portion of the novel jet-propelled lift-increasing and stability-increasing amphibious aircraft, the attitude sensor 42 is disposed at the stern of the novel jet-propelled lift-increasing and stability-increasing amphibious aircraft, and the pressure sensors 43 are disposed in the air chambers 70 to ensure the proper arrangement position of each measuring device to obtain more accurate navigation data.

A distance from the GPS velometer 41 and the attitude sensor 42 to the intelligent analysis device 50 is longer, so an information transmission module 44 is additionally disposed according to the present embodiment. The GPS velometer 41 and the attitude sensor 42 are electrically connected with the information transmission module 44 through cables, then, data detected by the GPS velometer 41 and the attitude sensor 42 are transmitted to the intelligent analysis device 50 in a wireless manner through the information transmission module 44, so that long-distance wire distribution is avoided.

Additionally, during jet control, the jet control device 60 receives an optimum jet signal from the intelligent analysis device 50, and gives a pressure adjusting instruction to the adjusting valve 80. When the pressure of the air chamber 70 is greater than a pressure value of the bottom pressure sensor 43, the jet plate 71 can automatically jet the air, and when the pressure of the air chamber 70 is equal to the pressure of the bottom pressure sensor 43, the jet plate 71 stops jetting the air.

Further, the navigation state sensing device further includes electronic flowmeters (not shown) disposed at the adjusting valves 80, and the electronic flowmeters measure the flow rate of air flowing into the air chambers 70, are configured to monitor the flow rate of the shunting pipeline 30 and transmit the flow rate to the jet control device 60.

The disclosure further provides an application method of the novel jet-propelled lift-increasing and stability-increasing amphibious aircraft. The application method is used to control the novel jet-propelled lift-increasing and stability-increasing amphibious aircraft. In a stage that the novel jet-propelled lift-increasing and stability-increasing amphibious aircraft planes on the surface to take off, the stage of taxiing takeoff on the water surface is divided into a hull-borne stage, a transition stage, a planing stage and a before-takeoff stage in different jet control modes. In a stage that the novel jet-propelled lift-increasing and stability-increasing amphibious aircraft leaves away from water and takes off to climb, the water leaving takeoff climbing stage is divided into a first stage of climb and a second stage of climb in different jet control modes. In a stage that the novel jet-propelled lift-increasing and stability-increasing amphibious aircraft flies in the air, the jet control mode is adjusted in a matched manner according to navigation data. In a stage that the novel jet-propelled lift-increasing and stability-increasing amphibious aircraft lands on water, the on-water landing stage is divided into a landing in-air stage, a water contacting impact stage and a water surface planing stage in different jet control modes.

In the hull-borne stage, a navigation velocity may be lower than 0.25 V_{ga}, the amphibious aircraft is generally in a motion state of trim by stern. Along with the velocity increase, a trim angle and water resistance are continuously increased. Additionally, there is an approximate linear relationship between the water resistance and the velocity, the main purposes in this stage are to control a change range of the trim angle, avoid the occurrence of trim of bow and decrease friction resistance components at the bottom of an aircraft body. The intelligent analysis device 50 gives a jet signal to the jet control device 60 according to a preset program, the air chambers 70 at the stern of the novel jet-propelled lift-increasing and stability-increasing amphibious aircraft are controlled for main jetting, the air chambers 70 at the bow portion of the novel jet-propelled lift-increasing and stability-increasing amphibious aircraft are controlled for auxiliary jetting, and the air chambers 70 at the step of the novel jet-propelled lift-increasing and stability-increasing amphibious aircraft are controlled to stop jetting, so as to adjust the dynamic pressure balance between the step and the outside.

In the transition stage, the navigation velocity is between 0.25 V_{ga} and 0.50 V_{ga}, the longitudinal trim angle and hydrodynamic resistance are firstly increased to reach peak values, and are then gradually decreased. At this stage, the main purposes are to reduce the peak values of the longitudinal trim angle and the resistance, alleviate the speed of the trim angle change before and after the peak values and avoid the occurrence of a longitudinal jumping motion phenomenon. The intelligent analysis device 50 sends a jet signal to the jet control device 60 according to a preset program, the air chambers 70 at the bow portion of the novel jet-propelled lift-increasing and stability-increasing amphibious aircraft are controlled not to jet, the jet quantity of the air chambers 70 at the stern of the novel jet-propelled lift-increasing and stability-increasing amphibious aircraft is increased, and the jet quantity of the air chambers 70 at the step of the novel jet-propelled lift-increasing and stability-increasing amphibious aircraft is retarded, and the stern water adsorption effect is reduced.

In the planing stage, the navigation velocity is between 0.5 V_{ga} and 0.8 V_{ga}, the aircraft body is further lifted, the rest immersion area is smaller, the bottom impact is greater, and the longitudinal trim angle and the hydrodynamic resistance of the amphibious aircraft are continuously reduced. The main purposes of this stage are to main the navigation stability, maintain the longitudinal trim angle in an attack angle range favorable for taxiing and reduce the taxiing resistance. The intelligent analysis device 50 sends a jet signal to the jet control device 60 according to a preset program, the jet quantity of the air chambers 70 at the step and the stern of the novel jet-propelled lift-increasing and stability-increasing amphibious aircraft is increased, and the aircraft body lifting dynamic lift force is improved.

In the before-takeoff stage, the navigation velocity is between 0.8 V_{ga} and 1.0 V_{ga}, the step is mainly in contact with water, the water flow sputtered at the step may seriously flush the bottom of the step to cause water dynamic resistance increase and form a second resistance peak. Then, the water dynamic resistance is fast deceased. The main purposes of this stage are to maintain the stable stage of the aircraft body, including transverse stability and longitudinal stability, avoid the occurrence of large-amplitude change of the navigation attitude, and improve the lift-increasing and stability-increasing effects. The intelligent analysis device 50 sends a jet signal to the jet control device 60 according to a preset program, all of the air chambers 70 are controlled to jet to achieve main jetting through the air chambers 70 at the step and near the step of the novel jet-propelled lift-increasing and stability-increasing amphibious aircraft and the auxiliary jetting through the air chambers 70 near the bow portion and near the stern of the novel jet-propelled lift-increasing and stability-increasing amphibious aircraft, so that the aircraft body is further lifted to a natural water leaving state.

In the first stage of climb, the aircraft is required to be capable of reaching a takeoff safety velocity before an altitude of 10.7 m. A climbing gradient and maneuverability can only be achieved after the takeoff safety velocity is achieved. The main purposes of this stage are to stabilize the fuselage and fast achieve the takeoff safety speed. The intelligent analysis device 50 sends a jet signal to the jet control device 60 according to a preset program. All of the air chambers 70 are controlled to jet, the jet quantity of the air chambers 70 at the bow portion of the novel jet-propelled lift-increasing and stability-increasing amphibious aircraft is fast increased when trim by bow occurs, and the jet quantity of the air chambers 70 at the stern of the novel jet-propelled lift-increasing and stability-increasing amphibious aircraft is fast increased when trim by stern occurs.

In the second stage of climb, the aircraft is required to continuously climb to the air higher than 120 m at a speed possibly close to but not lower than the takeoff safety velocity. The main purposes of this stage are to control the aircraft navigation velocity to be kept in a certain range, improve the aerodynamic efficiency at the same time and improve the lift-drag ratio. The intelligent analysis device 50 sends a jet signal to the jet control device 60 according to a preset program. The jet quantity of the air chambers 70 at the step of the novel jet-propelled lift-increasing and stability-increasing amphibious aircraft is increased, and the jet quantity of the air chambers 70 at the bow portion of the novel jet-propelled lift-increasing and stability-increasing amphibious aircraft is decreased.

In the in-air flying stage, the main purposes of this stage are to control the flight stability degree of the aircraft at the given navigation speed and optimize the aircraft airflow field to reduce its resistance. In the basic flight process, the air chambers 70 at the bow portion of the novel jet-propelled lift-increasing and stability-increasing amphibious aircraft are controlled not to jet, the air chambers 70 at the step of the novel jet-propelled lift-increasing and stability-increasing amphibious aircraft are controlled for main jetting, and the air chambers 70 at the stern of the novel jet-propelled lift-increasing and stability-increasing amphibious aircraft are controlled for auxiliary jetting. The resistance increased due to the existence of the step is reduced. At this moment, the intelligent analysis device 50 receives three-dimensional coordinate and navigation velocity information transmitted from the GPS velometer 41 and the longitudinal trim state signal transmitted from the attitude sensor 42, the intelligent analysis device 50 accumulates and analyzes the data of the velocity measured by the GPS velometer 41, the jet quantity of the air chambers 70 at the step and the little jet quantity of the air chambers 70 at the stern, and the optimum jet quantity is automatically optimized. Additionally, when trim by stern occurs, the jet quantity of the air chambers 70 at the stern of the novel jet-propelled lift-increasing and stability-increasing amphibious aircraft is increased. When trim by bow occurs, the jet quantity of the air chambers 70 at the stern of the novel jet-propelled lift-increasing and stability-increasing amphibious aircraft is decreased.

In the in-air landing stage, by controlling a throttle, an elevator and flaps, the aircraft keeps a glide slope, the stable approach is built at a recommended velocity according to the aircraft design, and the aircraft gradually approaches to the water surface. The main purposes of this stage are to keep the aircraft body to be in a stable gliding attitude and prevent the great-amplitude change of the navigation attitude. The jet control device 60 sends a jet signal. When an amplitude of trim by bow is greater than a preset threshold, the jet quantity of the air chambers 70 at the bow portion of the novel jet-propelled lift-increasing and stability-increasing amphibious aircraft is fast increased. When the amplitude of trim by bow is smaller than the preset threshold, the jet quantity of the air chambers 70 at the stern of the novel jet-propelled lift-increasing and stability-increasing amphibious aircraft is increased.

In the water contacting impact stage, from water surface approaching to smooth taxiing in water, the preparation is made for water contacting by smoothly lifting a nose when the aircraft approaches to the water surface. At this moment, the aircraft needs to maintain a certain power. In a moment of contacting with the water, the water surface may generate huge hydrodynamic impact force on the aircraft, a water contacting rebounding phenomenon of the aircraft body may even occur under an ultimate condition. Throttle back is gradually performed after the aircraft is smoothly in contact with water. The main purposes of this stage are to maintain the proper water contacting attitude and the water contacting velocity, avoid the nose pitching, reducing a violent impact load at the step at the same time, and improve the aircraft body stability and structure safety at the water entering moment. The jet control device 60 sends a jet signal, the jet quantity of the air chambers 70 at the bow portion and the step of the novel jet-propelled lift-increasing and stability-increasing amphibious aircraft is fast increased, and the jet quantity of the air chambers 70 at the stern of the novel jet-propelled lift-increasing and stability-increasing amphibious aircraft is fast adjusted according to attitude characteristics after water entering.

In the water surface planing stage, decelerated taxiing is performed, the aircraft motion may be regarded as stopped until the velocity is lower than 5 km/h. At this moment, a dominant effect of the aircraft body motion state is achieved by hydrodynamic force. An attitude angle in the water planing stage is basically kept unchanged or in a periodic oscillation state at the former half process, the main motion state parameters are gradually alleviated in the later half process, and the aircraft stably taxies after a rear body enters the water. The main purposes of this stage are to transmit the aircraft body from the water-entering impact state to the taxiing state, maintain the motion stability and reduce the motion amplitude value during taxiing. The jet control device 60 sends a jet signal, the jet quantity of the air chambers 70 at the bow portion of the novel jet-propelled lift-increasing and stability-increasing amphibious aircraft is firstly decreased, the jet quantity of the air chambers 70 at the stern of the novel jet-propelled lift-increasing and stability-increasing amphibious aircraft is decreased, and finally, the jet of all of the air chambers 70 is stopped.

The above mentioned are preferred implementations of the disclosure. It should be noted that several improvements and refinements may be made by those of ordinary skill in the art without departing from the principles of the disclosure, and these improvements and refinements are also to be considered within the scope of the disclosure.

What is claimed is:

1. A novel jet-propelled lift-increasing and stability-increasing amphibious aircraft,
comprising an air intake fan, a pressurized air storage tank, a shunting pipeline, a navigation state sensing device, an intelligent analysis device, a jet control device and a plurality of air chambers; wherein
the air intake fan connects and communicates an air intake end of the pressurized air storage tank, an air outlet end of the pressurized air storage tank connects and communicates with the shunting pipeline, the shunting pipeline respectively connects and communicates with the plurality of air chambers, each connection of the plurality of air chambers and the shunting pipeline is provided with an adjusting valve, and the plurality of air chambers are distributed in a plurality of positions of the bottom of the novel jet-propelled lift-increasing and stability-increasing amphibious aircraft, and are configured to jet air outwards;
the navigation state sensing device is configured to detect navigation data of the novel jet-propelled lift-increasing and stability-increasing amphibious aircraft and send the navigation data to the intelligent analysis device;
the intelligent analysis device is configured to analyze the navigation data, obtain a control scheme and send to the jet control device; and
the jet control device controls open and closed states of the adjusting valves according to the control scheme to adjust a jet state of the plurality of air chambers.

2. The novel jet-propelled lift-increasing and stability-increasing amphibious aircraft according to claim 1, wherein the bottom walls of the air chambers are jet plates, each of the jet plates are provided with a plurality of jet holes, and the jet plates are used as bottom plates of the novel jet-propelled lift-increasing and stability-increasing amphibious aircraft.

3. The novel jet-propelled lift-increasing and stability-increasing amphibious aircraft according to claim 2, wherein the air chambers are disposed between a bow portion and a step, at the step, and between the step and a stern of the novel jet-propelled lift-increasing and stability-increasing amphibious aircraft.

4. The novel jet-propelled lift-increasing and stability-increasing amphibious aircraft according to claim 1, wherein
the navigation state sensing device comprises a GPS velometer, an attitude sensor and pressure sensors;
the GPS velometer is configured to acquire real-time velocity, acceleration and three-dimensional coordinate information of the novel jet-propelled lift-increasing and stability-increasing amphibious aircraft;
the attitude sensor is configured to acquire angular velocity, course angle and attitude angle information of the novel jet-propelled lift-increasing and stability-increasing amphibious aircraft; and
the pressure sensors are disposed in the air chambers, and are configured to acquire air pressure information in the air chambers.

5. The novel jet-propelled lift-increasing and stability-increasing amphibious aircraft according to claim 1, wherein the navigation state sensing device further comprises electronic flowmeters disposed at the adjusting valves, and the electronic flowmeters measure the flow rate of air flowing into the air chambers.

6. An application method of the novel jet-propelled lift-increasing and stability-increasing amphibious aircraft, wherein
the application method is used to control the novel jet-propelled lift-increasing and stability-increasing amphibious aircraft according to claim 1, and comprises:
in a stage that the novel jet-propelled lift-increasing and stability-increasing amphibious aircraft planes on the surface to take off, dividing the stage into a hull-borne stage, a transition stage, a planing stage and a before-takeoff stage in different jet control modes;
in a stage that the novel jet-propelled lift-increasing and stability-increasing amphibious aircraft leaves away from water and takes off to climb, dividing the stage into a first stage of climb and a second stage of climb in different jet control modes;
in a stage that the novel jet-propelled lift-increasing and stability-increasing amphibious aircraft flies in the air, adjusting the jet control mode in a matched manner according to navigation data; and
in a stage that the novel jet-propelled lift-increasing and stability-increasing amphibious aircraft lands on water, dividing the stage into a landing in-air stage, a water contacting impact stage and a water surface planing stage in different jet control modes.

7. The application method according to claim 1, comprising:
in the hull-borne stage, controlling the air chambers at the stern of the novel jet-propelled lift-increasing and stability-increasing amphibious aircraft for main jetting, controlling the air chambers at the bow portion of the novel jet-propelled lift-increasing and stability-increasing amphibious aircraft for auxiliary jetting, and controlling the air chambers at the step of the novel jet-propelled lift-increasing and stability-increasing amphibious aircraft to stop jetting;
in the transition stage, controlling the air chambers at the bow portion of the novel jet-propelled lift-increasing and stability-increasing amphibious aircraft not to jet, increasing the jet quantity of the air chambers at the stern of the novel jet-propelled lift-increasing and stability-increasing amphibious aircraft, and retarding the jet quantity of the air chambers at the step of the novel jet-propelled lift-increasing and stability-increasing amphibious aircraft;
in the planing stage, increasing the jet quantity of the air chambers at the step and the stern of the novel jet-propelled lift-increasing and stability-increasing amphibious aircraft; and
in the before-takeoff stage, controlling all of the air chambers to jet to achieve main jetting through the air chambers at the step and near the step of the novel jet-propelled lift-increasing and stability-increasing amphibious aircraft and the auxiliary jetting through the air chambers near the bow portion and the stern of the novel jet-propelled lift-increasing and stability-increasing amphibious aircraft.

8. The application method according to claim 1, comprising:
in the first stage of climb, controlling all of the air chambers to jet, fast increasing the jet quantity of the air chambers at the bow portion of the novel jet-propelled lift-increasing and stability-increasing amphibious aircraft when trim by bow occurs, and fast increasing the jet quantity of the air chambers at the stern of the novel jet-propelled lift-increasing and stability-increasing amphibious aircraft when trim by stern occurs; and
in the second stage of climb, increasing the jet quantity of the air chambers at the step of the novel jet-propelled lift-increasing and stability-increasing amphibious aircraft, and decreasing the jet quantity of the air chambers at the bow portion of the novel jet-propelled lift-increasing and stability-increasing amphibious aircraft.

9. The application method according to claim 1, comprising:
in the in-air flying stage, controlling the air chambers at the bow portion of the novel jet-propelled lift-increasing and stability-increasing amphibious aircraft not to jet, controlling the air chambers at the step of the novel jet-propelled lift-increasing and stability-increasing amphibious aircraft for main jetting, and controlling the air chambers at the stern of the novel jet-propelled lift-increasing and stability-increasing amphibious aircraft for auxiliary jetting; and
when trim by stern occurs, increasing the jet quantity of the air chambers at the stern of the novel jet-propelled lift-increasing and stability-increasing amphibious aircraft, and when trim by bow occurs, decreasing the jet quantity of the air chambers at the stern of the novel jet-propelled lift-increasing and stability-increasing amphibious aircraft.

10. The application method according to claim 1, comprising:
in the in-air landing stage, when an amplitude of trim by bow is greater than a preset threshold, fast increasing the jet quantity of the air chambers at the bow portion of the novel jet-propelled lift-increasing and stability-increasing amphibious aircraft, and when the amplitude of trim by bow is smaller than the preset threshold, increasing the jet quantity of the air chambers at the stern of the novel jet-propelled lift-increasing and stability-increasing amphibious aircraft;
in the water contacting impact stage, fast increasing the jet quantity of the air chambers at the bow portion and the step of the novel jet-propelled lift-increasing and stability-increasing amphibious aircraft, and fast adjusting the jet quantity of the air chambers at the stern of the novel jet-propelled lift-increasing and stability-increasing amphibious aircraft according to attitude characteristics after water entering; and
in the water surface planing stage, firstly decreasing the jet quantity of the air chambers at the bow portion of the novel jet-propelled lift-increasing and stability-increasing amphibious aircraft, then decreasing the jet quantity of the air chambers at the stern of the novel jet-propelled lift-increasing and stability-increasing amphibious aircraft, and finally switching off the jet of all of the air chambers.
